(19) United States
(12) Patent Application Publication
(10) Pub. No.: US 2008/0238169 A1
(43) Pub. Date: Oct. 2, 2008

(54) VEHICLE SEAT ASSEMBLY HAVING AN ACCESSORY SYSTEM AND METHOD OF MAKING THE SAME

(75) Inventors: Thomas S. Hicks, Livonia, MI (US); Won-Tai Kim, Seoul (KR)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/694,120

(22) Filed: Mar. 30, 2007

(51) Int. Cl. B60N 2/02

(52) U.S. Cl. 297/353

(57) ABSTRACT

The present invention relates to a vehicle seat assembly having an accessory system and method of making the same. In at least one embodiment, the vehicle seat assembly comprises a seat cushion, a seat back having a top, and a bottom connected to the seat cushion such that the seat back is extendable in a generally upright position. The seat back comprises a seat frame and a pad supported by the frame. The seat assembly includes at least one support structure on the rear surface of the seat back and extending over at least 40 percent of the length or width of the seat back. The support structure is configured to selectively receive at least one vehicle occupant accessory having an attachment member.

### BACKGROUND OF THE INVENTION

1. Field of the Invention

The present invention relates to a vehicle seat assembly having an accessory system and method of making the same.

2. Background Art

Vehicle seat assemblies are known. Generally speaking, most vehicle seat assemblies include three fundamental components: (a) a frame to support the seat assembly and mount it to a vehicle body within an occupant compartment; (b) a foam cushion to cover the frame; and (c) trim material to cover the foam cushion and provide a durable surface for contact with a seat assembly occupant.

### SUMMARY OF THE INVENTION

According to at least one aspect of the present invention, a vehicle seat assembly is provided. In at least one embodiment, the vehicle seat assembly comprises a seat cushion and a seat back having a top and a bottom and being connected to the seat cushion such that the seat back is extendable in a generally upright position relative to the seat cushion. The seat back comprises a seat frame, a foam pad supported by the seat frame, and a trim material extending about the pad and the seat frame. The seat back has a front surface and an opposed rear surface. The vehicle seat assembly further comprises at least one support structure supported on the rear surface of the seat back. The support structure extends over at least 40 percent of the length or width of the seat back. The support structure is configured to selectively receive at least one vehicle occupant accessory having an attachment member.

In at least another embodiment, the vehicle seat assembly comprises a seat cushion and a seat back having a top and a bottom which is connected to the seat cushion such that the seat back is extendable in a generally upright position relative to the seat cushion. The seat back comprises a seat frame, a foam pad supported by the seat frame, and a trim material extending about the pad and the seat frame. The seat back has a front surface and an opposed rear surface. The vehicle seat assembly further comprises at least one support structure connected to the seat frame such that the structure is supported on the rear surface of the seat back. The support structure extends from a position adjacent the top of the seat back towards the bottom of the seat back over at least 40 percent of the length of the seat back and is configured to selectively receive at least one vehicle occupant accessory having an attachment member. The vehicle seat assembly further comprises at least one vehicle occupant accessory engaged with and supported on the support frame.

According to at least another aspect of the present invention, a method of making a vehicle seat assembly is provided. In at least one embodiment, the method comprises providing a seat cushion, providing a seat back having a top and a bottom, and connecting the seat back bottom to the seat cushion such that the seat back is extendable in a generally upright position relative to the seat cushion. The seat back comprises a seat frame, a foam pad supported by the seat frame, and a trim material extending about the pad and the seat frame. The seat back has a front surface and an opposed rear surface. The method further comprises supporting at least one support structure on the rear surface of the seat back such that the support structure extends from a position adjacent the top of the seat back towards the bottom of the seat back over at least 40 percent of the length of the seat back, with the support structure being configured to selectively receive at least one vehicle occupant accessory having an attachment member.

### BRIEF DESCRIPTION OF THE DRAWINGS

FIG. 1 is a partially exploded, rear perspective view of a vehicle seat assembly made in accordance with an embodiment of the present invention, illustrating various exemplary vehicle occupant accessories that can be usable with the present invention;

FIG. 2 is an exploded sectional view of a portion of the seat assembly illustrated in FIG. 1;

FIG. 3a is a schematic cross sectional view of an exemplary vehicle occupant accessory attached to a vehicle seat assembly in accordance with one embodiment of the present invention;

FIG. 3b is a schematic cross sectional view of an exemplary vehicle occupant accessory attached to a vehicle seat assembly in accordance with another embodiment of the present invention;

FIG. 4 is a partially exploded, rear perspective view of a vehicle seat assembly made in accordance with an embodiment of the present invention, illustrating an exemplary various occupant accessory that can be usable with the present invention in various states;

FIG. 5 is a view similar to FIG. 4 showing components in a different configuration;

FIG. 6 is a view similar to FIG. 5 showing the components in yet another configuration;

FIG. 7 is an exploded sectional view of a portion of the seat assembly illustrated in FIG. 4;

FIG. 8 is a view similar to FIG. 6 showing another exemplary accessory usable with the vehicle seat assembly of this embodiment;

FIG. 9 is a view similar to FIG. 6 showing yet another exemplary accessory usable with the vehicle seat assembly of this embodiment; and

FIG. 10 is a schematic, exploded, cross sectional view of an exemplary vehicle occupant accessory attached to a vehicle seat assembly in accordance with one embodiment of the present invention.

### DETAILED DESCRIPTION OF THE PREFERRED EMBODIMENT

As required, detailed embodiments of the present invention are disclosed herein. However, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

Moreover, except where otherwise expressly indicated, all numeral quantities in this description and in the claims are to be understood as modified by the word “about” in describing the broader scope of this invention. Practice within the numerical limits stated is generally preferred. Also, unless expressly stated to the contrary, the description of a group or class of materials may be suitable or preferred for a given purpose in connection with the invention implies that mixtures of any two or more members of that group or class may be equally suitable or preferred.

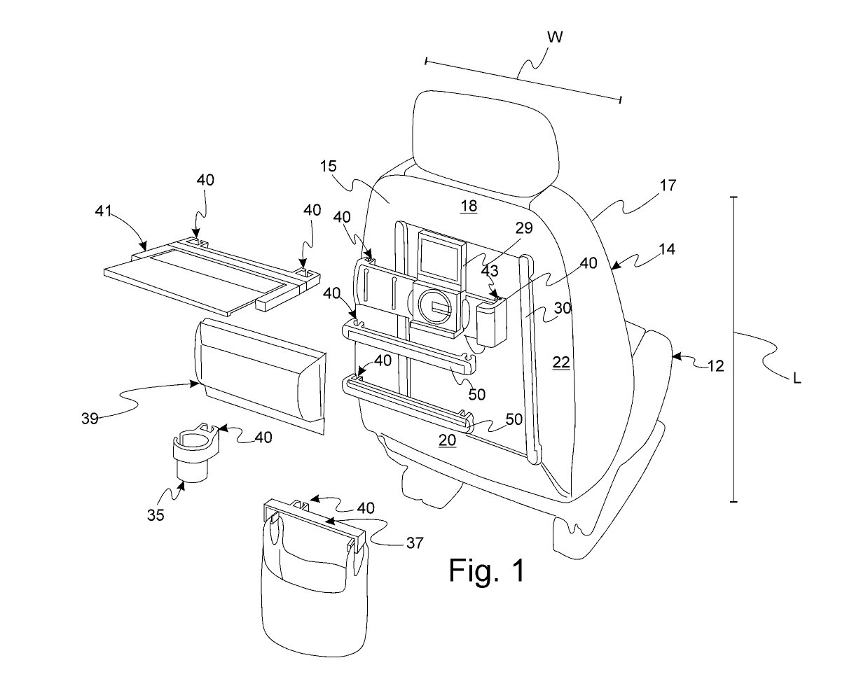

Referring now to the Figures, where like numerals are used to designate like structure throughout the drawings, a schematic vehicle seat assembly in accordance with at least one embodiment of the present invention is generally shown at 10 in FIG. 1. While the vehicle seat assembly 10 is illustrated in FIG. 1 to be a bucket seat assembly, it should be understood that the principles of the invention are applicable to other types of seat assemblies, such as bench, captain as well as other types of seat assemblies. It should also be understood that the principles of the present invention could also be applicable to other vehicle interior components such as door and other trim panels, consoles and modules.

As shown in FIG. 1, the vehicle seat assembly 10 includes a seat cushion 12 and a seat back 14. The seat back 14 has a top portion 18, a bottom portion 20, and an intermediate portion 22 extending between the top and bottom portions of the seat back. The seat back 14 has a rear surface 15 facing the back of the vehicle and an opposed front surface 17 facing the front of the vehicle. The bottom portion 20 of the seat back 14 is connected to the seat cushion 12 in any suitable manner, but is generally pivotally connected to enable the seat back to extend in a generally upright position relative to the seat cushion 12.

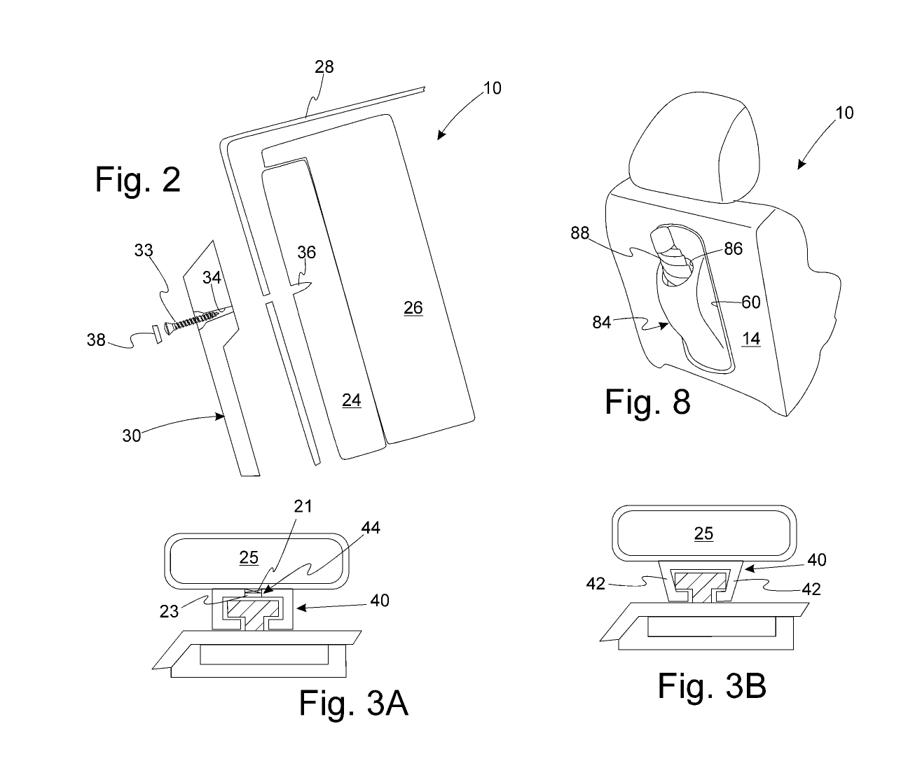

As schematically shown in FIG. 2, in at least one embodiment, the seat back 14 comprises a seat back frame 24, a foam pad 26 supported by the seat back frame 24, and a trim material 28 that extends about and covers the frame 24 and the foam pad 26. While not specifically illustrated, it should be understood that the seat cushion 12 will have a similar construction including a seat cushion frame, a foam pad and trim material similar to that illustrated and described with respect to seat back 14 herein in FIG. 2.

Moreover, the seat frame 24 may be constructed from any material suitable for application within a vehicle seat assembly, such as aluminum, steel, another metal alloy, or a suitable polymer. Further, the seat frame 24 may be manufactured using a technique commonly known in the art, relative to the type of material employed. By way of example, manufacturing techniques may include stamping, welding, fastening or molding a suitable to form a seat frame 24.

The foam pad 26 can be made of any suitable type of foam, such as for instance polyurethane foam. It should also be understood that the pad 26 could also be made of some, or even all, non-foam material. The seat foam pad 26 may be conventionally secured to the seat frame 24 in any suitable manner, such as by an adhesive.

The trim material 28, as set forth above, is adapted to engage the foam pad 26 and the frame 24 in a covering relationship. The trim material 28 may include any material commonly known in the art. By way of example, some of the known materials includes cloth, leather or polymers of sufficient quality and thickness for use in seat trim applications. Polymer trim materials may include a flexible closed cell polymer skin material such as polyvinyl chloride (PVC), thermoplastic olefin (TPO) or thermoplastic urethane (TPU). Additionally, materials for use as trim material 28 may include a foam backing (not shown, but generally known in the art), which may be manufactured by a variety of polymeric foam materials.

Referring back to FIG. 1, a spaced apart pair of seat back panel rails 30 are shown to be supported on the seat back 14. Specifically, the seat back panel rails 30 are disposed on the rear surface 15 of the seat back 14. While the seat back panel rails 30 may be secured to the seat back 14 in any suitable manner, in at least one embodiment, the seat back panel rails are secured to the seat frame 24 in a suitable manner. As shown in FIG. 2, in at least this embodiment, the rails 30 may be provided with fastener opening 34 to enable a fastener 33, such as a screw or other types of threaded or non-threaded fasteners, to extend through the trim material 28 (or through a trim material cutout) into the frame 24, such as into the schematically illustrated screw bore 36. A cap 38 may be provided for covering the fastener opening 34.

As shown in FIG. 1, the seat back panel rails 30 are spaced apart from each other. In at least one embodiment, the seat back panel rails are spaced apart 20 to 50 centimeters, and in at least another embodiment 25 to 40 cm.

As shown in the embodiment illustrated in FIG. 1, the seat back panel rails 30 extend generally the length of the intermediate portion 22 of the seat back 14. The length of the seat back is generally between 65 to 115 cm, with the intermediate portion 22 of the seat back being about 40 to 80 cm. In at least one embodiment, the seat back panel rails 30 extend over at least 40 percent of the length L of the seat back 14, and in at least another embodiment between 50 and 90 percent of the length L of the seat back, while in yet another embodiment between 60 and 75 percent of the length L of the seat back. This length of the rails 30 provides a sufficient amount of space on the seat back 14 to provide a variety of vehicle occupant accessories. This provides the seat back with the ability/flexibility to be selectively configured to have a desired amount of, and variety of, vehicle occupant accessories. While the rails 30 are shown to extend over a substantial, at least 40%, of the length of the seat back 14, it should be understood that the rails could extend similarly in the transverse direction, i.e., over at least 40% of the width W of the seat back.

The vehicle occupant accessories are accessories that the vehicle occupant would find useful to have while being a passenger in the vehicle, particularly a passenger in the back seat of the vehicle. For instance, exemplary suitable vehicle occupant accessories are shown in FIG. 1 and include, but are not necessarily limited to, a cup holder 35, a trash bag holder 37, map pocket 39, a tray 41, and a media holder 43 which can hold a portable DVD player, CD player, video game console, rear seat entertainment/infotainment or the like, schematically illustrated at 29.

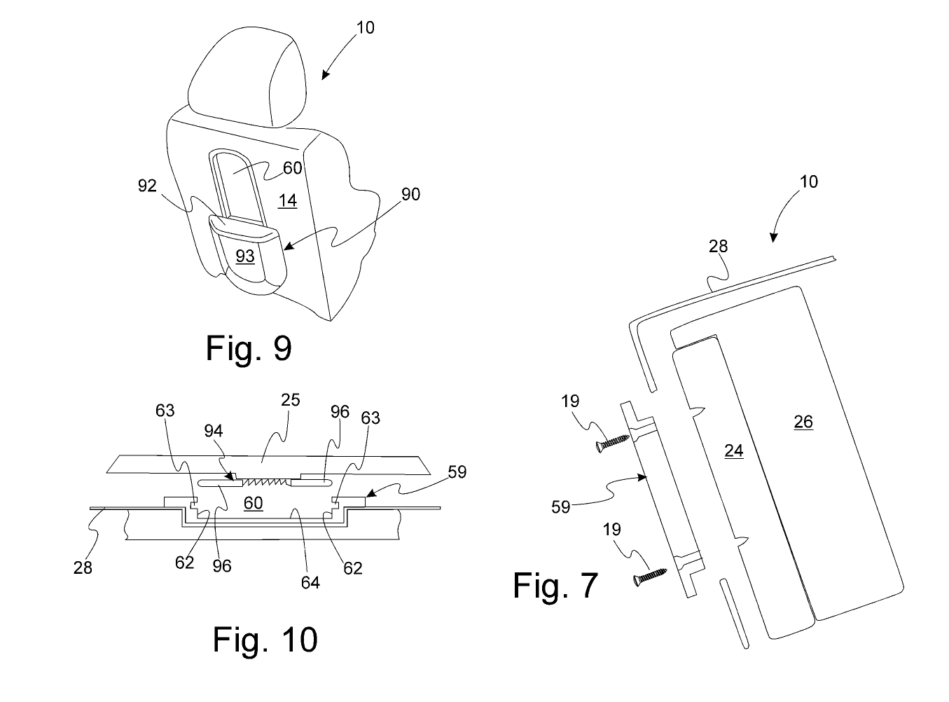

Each of the vehicle occupant accessories will include at least one attachment member, which is schematically illustrated in FIG. 1 to be one or more clips 40, which can be selectively engageable with one or more of the seat back panel rails 30. FIGS. 3a, 3b and 7 illustrate a schematic exemplary vehicle occupant accessory, illustrated as 25, secured to the seat back 14 in accordance with various aspects of the invention. While the accessory 25 is schematically represented for simplicity sake, it should be understood that any suitable vehicle occupant accessory could be employed in accordance with the present invention. As best shown in FIG. 3b, the attachment member(s)/clip(s) 40 will comprise a pair of arms 42, at least one of which is deformable to allow the arms 42 to be selectively engageable with a respective seat back panel rail 30. The clips 40 could be made of any suitable material such as plastic or metal.

As shown in FIG. 3a, the attachment member 40 could alternatively have a spring loaded member 44, such as a tab 23 biased by a spring 21 towards the rail 30, that biases the attachment member 40 against the rail 30.

Referring back to FIG. 1, to provide an additional level of selectivity and versatility, a pair of selectively spaceable cross rails 50 could be provided to enable relatively larger vehicle accessories (or storage devices), such as map pocket 32 and other large accessories to be secured to the rails 30. The large accessories, such as map pocket 39, are engageable with the cross rails 50 and the cross rails have attachment member 40 which are selectively engageable with the seat back panel rails 30.

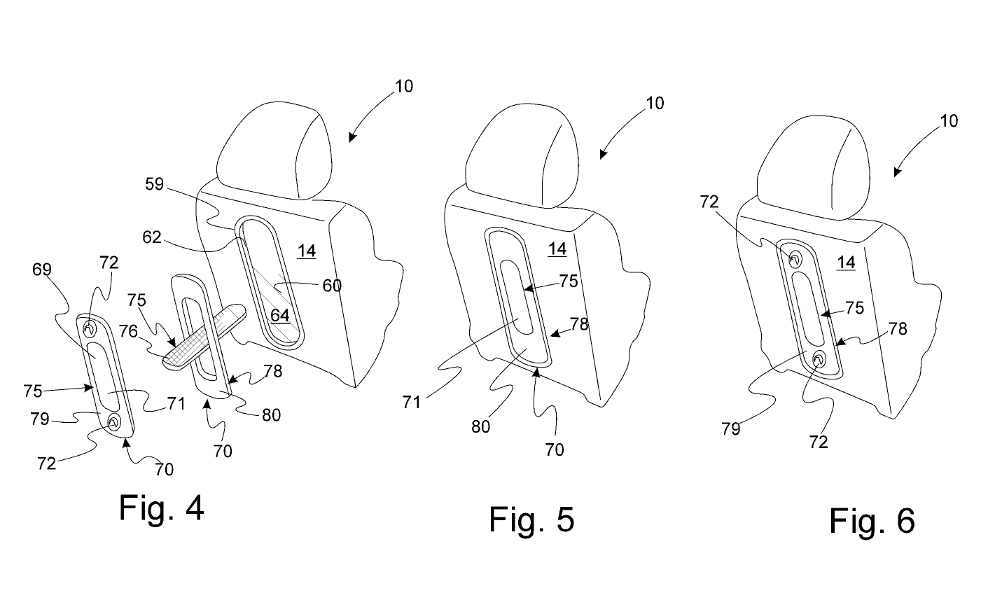

Referring to FIG. 4, another embodiment of the vehicle seat assembly of the present invention is illustrated. In this embodiment, the seat back 14 is provided with or supports an accessory plate 59. The accessory plate 59 forms a channel 60 which can be any suitable shape but is shown in FIG. 4 to be a generally rectangular or extended oval shape. The channel 60, as best shown in FIG. 7, is formed by opposed sidewalls 62 that extend generally perpendicularly from a base surface 64 that extends between the sidewalls 62. It should be readily understood that the sidewalls 62 can be one continuous sidewall, as shown in the figures, or could be separate sidewalls that cooperate to form the channel 60. The sidewalls 62 include a ridge 63.

In the embodiment illustrated in FIG. 4, a vehicle occupant accessory, such as bag holder 70 comprising a pair of spaced apart hooks 72, is shown to be insertable and held within the channel 60. As can be envisioned, and will be explained below with respect to FIGS. 8 and 9, various other vehicle accessories can be used beside the illustrated bag holders 70.

In at least the embodiment illustrated in FIG. 4, the base surface 64 of the plate 59 comprises a strip of Velcro®, or other securable surface, and the vehicle occupant accessory 70 comprises a base member 75 having a first side 77 having a corresponding strip of Velcro® 76, or other securable surface, which can be used to hold the vehicle occupant accessory 70 within the channel 60 by the locking engagement of the first and second strips of Velcro® 64 and 76 with respect to each other. The other side 69 of base member 75 comprises a trim covered surface 71. As can be seen in FIG. 4, the vehicle occupant accessory 70 has a pivotal member 78 that is supported by the base member 75. The pivotal member 78 comprising a first side having trim-covered surface 80 and an opposed side 79 having the occupant accessory surface such as the bag hooks 72.

Referring to FIG. 5, when the vehicle occupant accessory 70 is not desired to be used, the pivotal member 78 can be pivoted such that the trim surfaces 71 and 80 of the base member 75 and the pivotal member 78 respectively, can be facing the same way i.e., towards the rear of the vehicle with the Velcro® strip 76 lockingly engaged with the Velcro® strip 64. This provides a “clean”, relatively seamless trim appearance to the seat back 14.

Referring to FIG. 6, when the vehicle occupant accessory 70 is desired to be used, the pivotal member 78 is pivoted so that surface 79 with the hooks 72 can be facing the rear seats, with the trim surface 78 facing the Velcro® strip 64.

As discussed above, it is envisioned that a variety of various vehicle occupant accessories could be employed within the channel 60 illustrated in FIG. 4, and the types of accessories are not to be limited by the disclosure herein, which should be considered exemplary. As shown in FIG. 8, an umbrella holder 84 could be employed for use wherein the umbrella holder has a receptacle 86 for receiving an umbrella 88. It should be understood that the receptacle 86 could be employed for receiving a variety of other items such as a bottle of liquid, maps and books, trash, sunglasses, etc.

Referring to FIG. 9, yet another vehicle occupant accessory 90 is illustrated. This vehicle occupant accessory 90 comprises a storage bin/wet garbage bin which includes a cover 92 that allows access to an enclosable receptacle 93.

Referring to FIG. 10, an alternative mechanism for securing the schematically illustrated accessory 25 within the channel 60 is illustrated. In this embodiment, the accessory 25 could be provided with a spring loaded engagement mechanism 94 that has opposed members 96 that are biased away from each other via a spring 98 such that the members 96 are engageable with the ridge 63 formed in the channel 60.

Referring to FIG. 7, the accessory plate 59 can be secured to the frame 24 by any suitable mechanism, such as by fasteners 19 such as screws. Alternatively, other types of security mechanisms can be envisioned and as such can be employed. Moreover, it should be understood that the accessory plate 59 could be omitted so long as the seat back is formed or provided, with a channel for holding the accessories.

It should be understood that the rails 30 and accessory plates 59 can be made out of any suitable material and by any suitable process. For instance, the rails 30 and channel member 60 can be made of any suitable plastic or metallic material and could be made by any suitable molding process or stamping.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A vehicle seat assembly comprising:
a seat cushion;
a seat back having a top and a bottom, the seat back bottom being connected to the seat cushion such that the seat back is extendable in a generally upright position relative to the seat cushion, the seat back comprising a seat frame, a foam pad supported by the seat frame, and a trim material extending about the pad and the seat frame, the seat back having a front surface and an opposed rear surface; and
at least one support structure on the rear surface of the seat back, the support structure extending over at least 40 percent of the length or width of the seat back, the support structure being configured to selectively receive at least one vehicle occupant accessory having an attachment member.

2. The vehicle seat assembly of claim 1 wherein the support structure is capable of receiving a plurality of vehicle occupant accessories.

3. The vehicle seat assembly of claim 1 wherein the support structure is connected to the vehicle seat frame.

4. The vehicle seat assembly of claim 1 wherein the support structure comprises a pair of parallel rails.

5. The vehicle seat assembly of claim 4 wherein the attachment member is selectively supportable on at least one of the parallel rails.

6. The vehicle seat assembly of claim 4 wherein the attachment member comprises a clip engageable with at least one of the rails.

7. The vehicle seat assembly of claim 4 wherein the attachment member comprises at least two clips each of which is engageable with a respective one of the rails.

8. The vehicle seat assembly of claim 1 wherein the support structure extends between 50 to 90 percent of the length of the seat back.

9. The vehicle seat assembly of claim 1 wherein the support structure comprises a generally rectangular channel defined by opposed sidewalls and a base surface extending between the opposed sidewalls.

10. The vehicle seat assembly of claim 9 wherein the sidewalls include ridges, and the attachment member comprises opposed abutment surfaces engageable with the ridges to provide an interference fit between the attachment member and the support structure.

11. The vehicle seat assembly of claim 9 wherein the sidewalls include ridges and the attachment member comprise a spring-loaded biasing member engageable with the opposed ridges.

12. The vehicle seat assembly of claim 9 wherein the base surface comprises a first Velcro® strip.

13. The vehicle seat assembly of claim 12 wherein the attachment member comprises a second Velcro® strip that is engageable with the first Velcro® strip.

14. The vehicle seat assembly of claim 13 wherein the second Velcro® strip is supported on the accessory in a pivotal manner.

15. The vehicle seat assembly of claim 1 wherein the vehicle accessory comprises a cup holder.

16. The vehicle seat assembly of claim 1 wherein the vehicle accessory comprises a tray.

17. The vehicle seat assembly of claim 1 wherein the vehicle accessory comprises a bag holder.

18. The vehicle seat assembly of claim 1 wherein the vehicle accessory comprises a wet/dry trash bin.

19. A vehicle seat assembly comprising:
a seat cushion;
a seat back having a top and a bottom, the seat back bottom being connected to the seat cushion such that the seat back is extendable in a generally upright position relative to the seat cushion, the seat back comprising a seat frame, a foam pad supported by the seat frame, and a trim material extending about the pad and the seat frame, the seat back having a front surface and an opposed rear surface;
at least one support structure connected to the seat frame such that the structure is supported on the rear surface of the seat back, the support structure extending from a position adjacent the top of the seat back towards the bottom of the seat back over at least 40 percent of the length of the seat back, the support structure being configured to selectively receive at least one vehicle occupant accessory having an attachment member; and
at least one vehicle occupant accessory engaged with and supported on the support frame.

20. A method of making a vehicle seat assembly, the method comprising:
providing a seat cushion;
providing a seat back having a top and a bottom;
connecting the seat back bottom to the seat cushion such that the seat back is extendable in a generally upright position relative to the seat cushion, the seat back comprising a seat frame, a foam pad supported by the seat frame, and a trim material extending about the pad and the seat frame, the seat back having a front surface and an opposed rear surface; and
supporting at least one support structure on the rear surface of the seat back such that the support structure extends from a position adjacent the top of the seat back towards the bottom of the seat back over at least 40 percent of the length of the seat back and the support structure being configured to selectively receive at least one vehicle occupant accessory having an attachment member.
